(19) United States
(12) Patent Application Publication
(10) Pub. No.: US 2008/0016441 A1
(43) Pub. Date: Jan. 17, 2008

(54) Method and Apparatus to Facilitate Altering a Presentation Order for Search Results

(76) Inventor: Joshua Z. Tabin, Podebrady (CS)

Correspondence Address: FITCH EVEN TABIN AND FLANNERY, 120 SOUTH LA SALLE STREET, SUITE 1600, CHICAGO, IL, 60603-3406, US

(21) Appl. No.: 11/774,332

(22) Filed: Jul. 6, 2007

Related U.S. Application Data
(63) Continuation-in-part of application No. 11/327,277, filed on Jan. 6, 2006.

(51) Int. Cl. G06F 3/00

(52) U.S. Cl. 715/700

(57) ABSTRACT

A plurality of search results and a plurality of user-alterable graphic user interface elements are provided simultaneously (101) via a display (200). These search results correspond to a general search conducted using a plurality of search criteria. The aforementioned user interface elements, in turn, each correspond to at least one of these search criteria. So configured and arranged, the plurality of user-alterable graphic user interface elements serve to illustrate current weighting values as correspond to the search criteria as are applied when determining a presentation order for the search results. Upon detecting (104) direct user alteration of a given one of the user-alterable graphic user interface elements, which alteration causes a change in the weighting value that corresponds to a given one of the user-alterable graphic user interface elements, one can then automatically alter (105) the presentation order for the search results.

### RELATED APPLICATIONS

This application comprises a continuation in part of METHOD AND APPARATUS FOR INTERACTIVE CRITERIA-BASED COMMODITY COMPARISONS as was filed on Dec. 11, 2006 and which has been accorded application Ser. No. 11/327,277.

### TECHNICAL FIELD

This invention relates generally to the conduct of general searches using a plurality of search criteria and more particularly to the presentation of corresponding search results.

### BACKGROUND

Search engines are known in the art. Search engines generally serve to evaluate a large and widely disparate volume of informational resources with respect to their potential relevance as determined with reference to search criteria comprising one or more terms or expressions of interest to a given user. Relevant examples in this regard would certainly include the search engines and services offered by Google, Yahoo, and MSN. These specific examples permit a user to input one or more alphanumeric entries of choice and then evaluate the previously cataloged and analyzed content of millions of separate and independent websites/webpages for corresponding similarities.

In many cases, such a general search will yield a large number of potentially relevant (though ultimately non-relevant) identified informational resources. This number can easily surpass the ability of a given user interface to reasonably present all such findings or even the ability of such a user to peruse and consider each such independent finding. To meet this concern, it is known in the art to present at least some of the search results in an order of presentation that favors some sense of order of relevance with respect to the inquiring party's focus of interest. The specific basis upon which such ordering occurs will typically vary from one search service to another and in many cases is maintained, at least in part, in confidence.

It is of course possible (or even likely) that the process by which a given search engine will order its search results will not, in fact, present those results in an order that is most appropriate to a given user. To attempt to redress this inherent inadequacy, many search services will provide the user with an opportunity to identify a particular search result entry as being an example of that which the user is interested in finding. In this case, the search service can then reorder its search results to initially present more of the findings that are akin in some manner to the identified search result. Again, however, there are numerous instances when such an approach fails to reorder the search results in a wholly satisfactory manner.

### BRIEF DESCRIPTION OF THE DRAWINGS

The above needs are at least partially met through provision of the method and apparatus to facilitate altering a presentation order for search results described in the following detailed description, particularly when studied in conjunction with the drawings, wherein:

FIG. 1 comprises a flow diagram as configured in accordance with various embodiments of the invention;

FIG. 2 comprises a schematic example of a display as configured in accordance with various embodiments of the invention;

FIG. 3 comprises a schematic example of a display as configured in accordance with various embodiments of the invention;

FIG. 4 comprises a schematic example of a display as configured in accordance with various embodiments of the invention;

FIG. 5 comprises a schematic example of a display as configured in accordance with various embodiments of the invention;

FIG. 6 comprises a schematic example of a display as configured in accordance with various embodiments of the invention;

FIG. 7 comprises a block diagram as configured in accordance with various embodiments of the invention;

FIG. 8 comprises a schematic example of a display as configured in accordance with various embodiments of the invention;

FIG. 9 comprises a schematic example of a display as configured in accordance with various embodiments of the invention; and

FIG. 10 comprises a schematic example of a display as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a plurality of search results and a plurality of user-alterable graphic user interface elements are provided simultaneously via a display. These search results correspond to a general search that was conducted using a plurality of search criteria. The aforementioned user interface elements, in turn, each corresponds to at least one of these search criteria. So configured and arranged, the plurality of user-alterable graphic user interface elements serve to illustrate current weighting values as correspond to the search criteria as are applied when determining a presentation order for the search results. If desired, by one approach, at least one of these search criteria can comprise a specific search engine to be employed when conducting the aforementioned general search.

These teachings also then provide for detecting direct user alteration of a given one of the user-alterable graphic user interface elements, which alteration causes a change in the weighting value that corresponds to a given one of the user-alterable graphic user interface elements. This, in turn, supports automatically altering the presentation order for the search results as a function of detecting such direct user alteration of this user interface element.

By one approach, as desired, these teachings will accommodate automatically altering other of the weighting values as correspond to other of the user-alterable graphic user interface values as a function of the aforementioned change to the weighting value that corresponds to the given one of the user-alterable graphic user interface element. This alteration can include, if desired, ensuring that an aggregate sum of the current weighting values as corresponds to all of the user-alterable graphic user interface elements continues to comprise a particular value. These teachings will also accommodate, if desired, ensuring, to an extent reasonably possible, that the current weighting values for each non-user-alterable graphic user interface element continues to maintain their relative value vis-à-vis one another (even notwithstanding previous automatic adjustment of the current weighting values to a point of equality (such as to a common value of zero)).

These teachings are also applicable for use when conducting a general search as described using the plurality of search criteria with a plurality of independent general search engines. In such a case, if desired, the aforementioned user-alterable graphic user interface elements can serve to illustrate (and permit manipulation of) current weighting values as correspond to the independent general search engines as are applied when determining a presentation order for the search results. Those skilled in the art will recognize and appreciate that this, in turn, permits a user to flexibly and dynamically influence and direct an order of presentation for the results of a multi-search service search as a function, at least in part, of which search engine returned the search result.

So configured and arranged, these teachings provide a simple and intuitive mechanism by which a user can directly and quickly influence and direct an order of presentation by which the results of a general search are presented. Those skilled in the art will recognize that these teachings are highly flexible and will readily serve to leverage the capabilities of numerous search services as may presently exist or as may be developed going forward. It will also be understood and appreciated that these teachings are highly scalable and can be employed with essentially any number of search criteria.

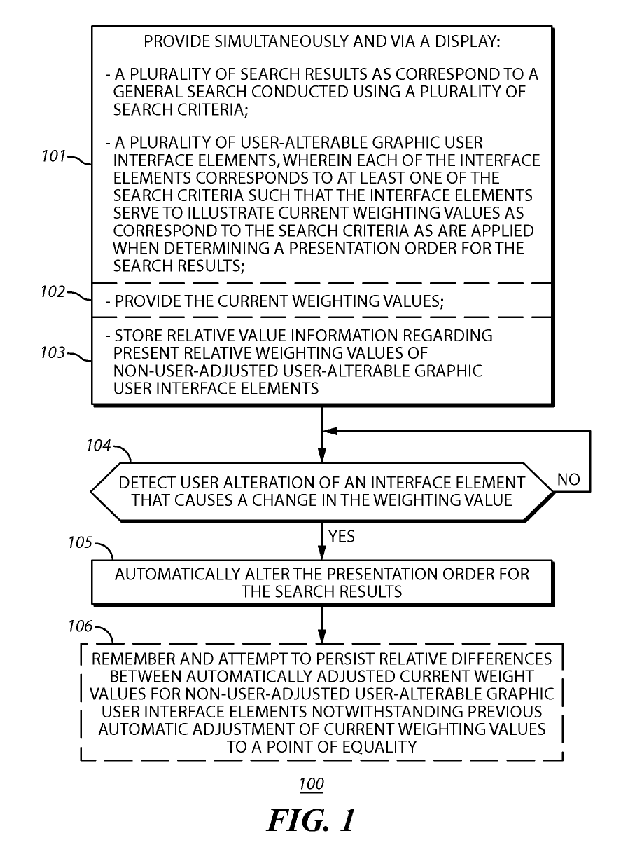

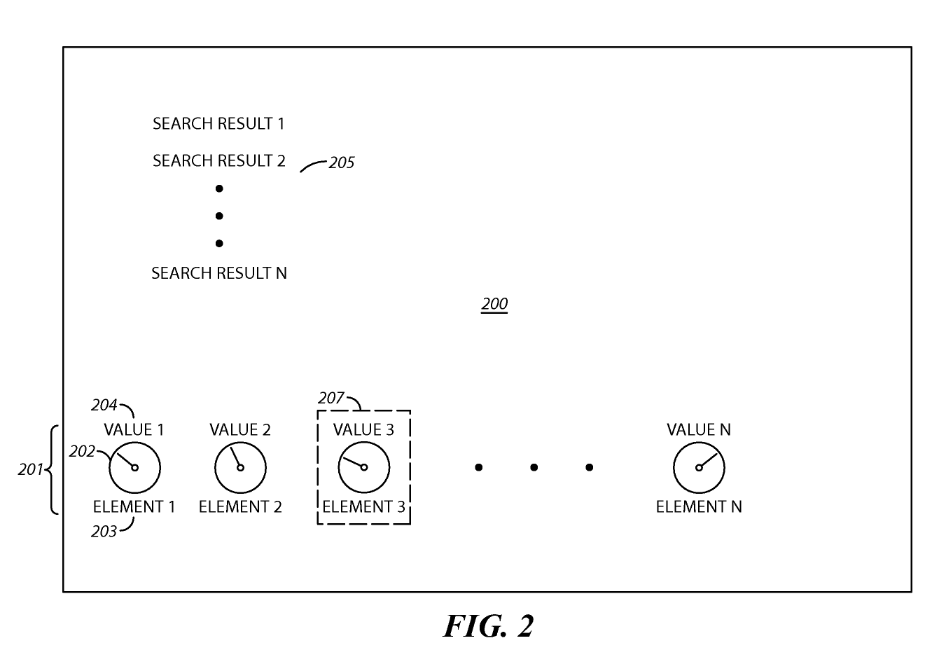

These and other benefits may become clearer upon making a thorough review and study of the following detailed description. Referring now to the drawings, and in particular to FIG. 1, a process 100 as corresponds with these teachings provides for provision 101 (via, for example, a display of choice) of a plurality of search results 205 (as shown in the schematic view presented in FIG. 2 of a display 200) as correspond to a general search that was conducted using a plurality of search criteria. As used herein, this reference to a general search will be understood to refer to a search of a general database that contains various items of disparate and unrelated content as versus, say, a search of a dedicated content or dedicated purpose database such as a consumer products database, a health records database, a financial records database, or the like.

Also as used herein, references to search criteria will be understood to refer to, for example, words (which may comprise complete words and/or word fragments) as are entered by a user who seeks to conduct the general search. Practice in this regard is well known in the art and these teachings are not particularly sensitive to the selection of any particular approach. Those skilled in the art will recognize and understand that these teachings are applicable, if desired, with search criteria that make use of so-called universal or wild card characters (where a given alphanumeric symbol can serve to represent one or more other alphanumeric characters).

This step 101 also comprises simultaneously providing a plurality of user-alterable graphic user interface elements, wherein each of these user-alterable graphic user interface elements corresponds to at least one of the plurality of aforementioned search criteria. Pursuant to these teachings, this plurality of user-alterable graphic user interface elements serve to illustrate current weighting values as correspond to the search criteria as are applied when determining a presentation order for the search results. These user-alterable graphic user interface elements can assume any of a wide variety of form factors as may be presently known or developed hereafter. Some examples would include, but are not limited to, renderings of slider tools, rotating knobs, a push, hold, and/or drag button, a touch screen element, and/or a select, drag, and drop value.

As noted, these user-alterable graphic user interface elements serve to illustrate current weighting values as correspond to the associated search criteria as are applied when determining a presentation order for the search results. If desired, these teachings will also optionally accommodate providing 102 (via, for example, the same display) these current weighting values as correspond to at least some of these user-alterable graphic user interface elements.

In the example shown in FIG. 2, a row of user-alterable graphic user interface elements 201 are provided which, in this embodiment, are represented by virtual rotating knobs 202 that can be rotated clockwise or counter clockwise to adjust their corresponding weighting values. The display may contain as many user-alterable graphic user interface elements as are necessary and/or appropriate to represent the applied search criteria. Each user-alterable graphic user interface element can have a label 203 to reflect, directly or indirectly as desired, the search criteria as corresponds to this particular element. In addition, the corresponding current weighting value 204 for each user-alterable graphic user interface element can be displayed.

If desired, this step can also optionally accommodate storing 103 relative value information regarding present relative weighting values of non-user-alterable graphic user interface elements to provide stored relative value information for purposes that are described further herein.

At this point it may be noted that these teachings will accommodate treating multiple search engines themselves as search criteria. That is, it is possible to provide a shared front-end general search application that takes the search criteria as entered by a given user and then submits those search criteria to two or more independent general search engines. To illustrate, separate searches by each of Google, Yahoo, and MSN can be commonly initiated in such a manner. In such a case, one of the user-alterable graphic user interface elements as described herein can be presented for each such search engine when presenting the aggregated search results.

This process 100 then provides for detecting 104 when direct user alteration of a given one of the user-alterable graphic user interface elements occurs, which alteration causes a change in the weighting value that corresponds to the given one of the user-alterable graphic user interface elements. When such an event occurs, this process 100 then provides for automatically altering 105 the presentation order for the search results. When the altered user-alterable graphic user interface element corresponds to a given search engine as noted above, this can comprise determining a presentation order for the combined search results that takes into account the user-based re-weighting of the user-alterable graphic user interface element as corresponds to the selected search engine.

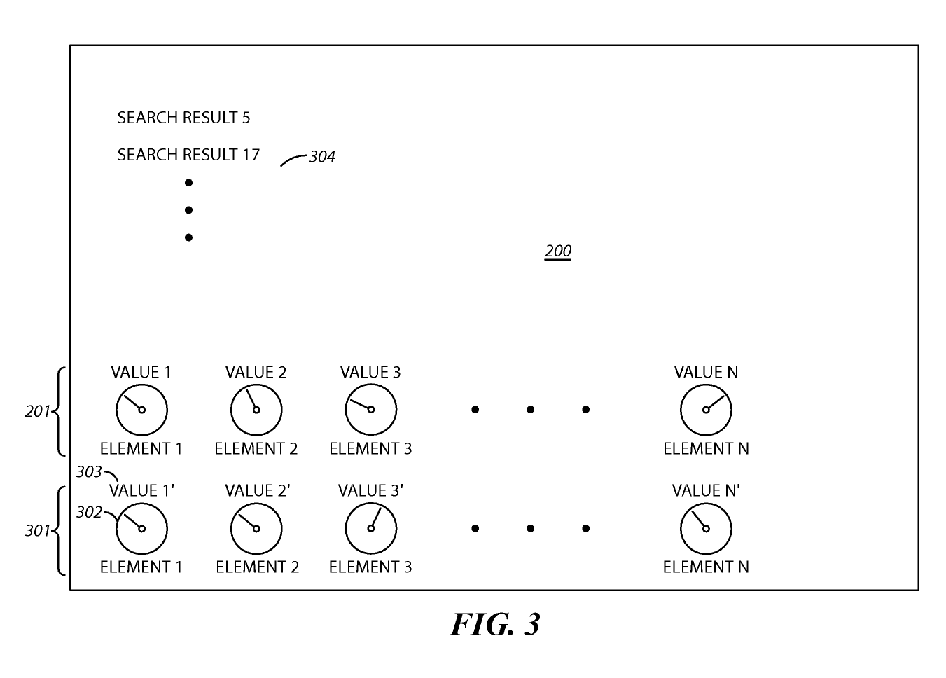

To continue with the illustrative example begun above, and referring now momentarily to FIG. 3, the third element 207 as corresponds to a given search criteria is increased by the user by turning the knob counter clockwise. In this illustrative example the adjusted current weighting values are now shown in a second row of user-alterable graphic user interface elements 301, with the initial settings being shown in the first row 201. (If desired, of course, further display of the initial settings can be discontinued and only the current settings can be shown.) The third element value increased, and therefore the remaining elements were decreased so that the aggregate sum of the weighting values would not exceed the specified value. However, in this illustrative example, the relative positions of the remaining elements vis-à-vis one another are maintained. The positions of the rotating knobs 302 reflect the adjustment and the corresponding adjusted weighting values 303 are displayed. In addition the search results now displays a new presentation order 304 based on the newly adjusted element settings.

As noted above, this process 100 will optionally accommodate storing 103 relative value information regarding present relative weighting values of non-user-alterable graphic user interface elements. In such a case, and if desired, this process 100 will then further optionally provide for remembering and attempting to persist 106 relative differences between automatically adjusted current weight values for non-user-alterable graphic user interface elements notwithstanding previous automatic adjustment of current weighting values to a point of equality.

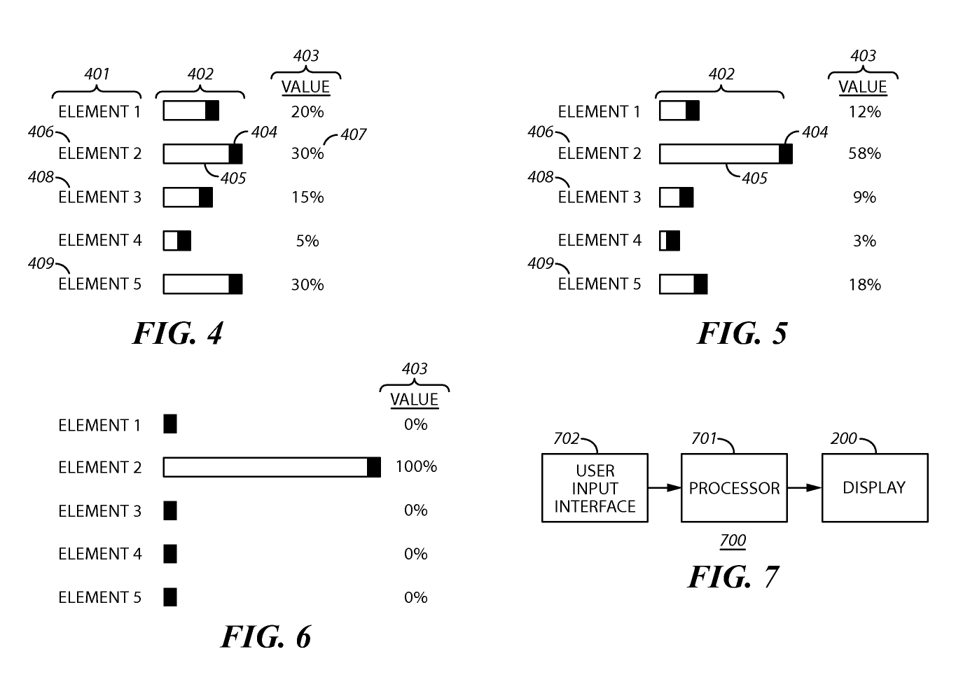

To illustrate, and referring now to FIG. 4, a schematic example of a plurality of user-alterable graphic user interface elements are shown. In this example, a column 401 of five user-alterable graphic user interface elements is provided, with each element relating to a corresponding search criterion. The elements are each graphically depicted by slider tools 402, with each slider tool having an associated weighting value as displayed in the value column 403. The slider tool for each element may be adjusted by selecting the end portion of the tool 404 (using any known computer input device) and sliding the end portion 404 to the right or the left, thereby increasing or decreasing the length portion 405 and the corresponding weighting value 407. It should be noted that in this illustration, the aggregate sum of the weighting value totals 100%.

In this illustration, the elements are initially set as shown in FIG. 2. Specifically, Element 2 406 is currently assigned a value of 30%, as shown in the value column 403. However, a user may decide that Element 2 406 should be assigned a higher value because the feature associated with that element's criterion is of more importance to the user. Therefore, the user would move the end portion 404 of the slider tool, thereby increasing the length portion 405 and the weighting value 407. The relative weighting values of the remaining four non-adjusted elements are then stored. When Element 2 406 is adjusted upward, the remaining elements are adjusted downward, so that the aggregate sum of the weighting values will not exceed 100%. The weighting values of the remaining four elements, however, will be adjusted such that the elements continue to maintain their relative values vis-à-vis one another.

This relative movement can be seen in FIG. 5. In this illustration, Element 2 406 has been increased to a value of 58%. For the remaining four user-alterable graphic user interface elements, the weighting values listed in the value column 403 of FIG. 5 have gone down from the values that were displayed for those elements in the value column 403 of FIG. 4, so that the total remains at 100%. The slider tools 402 have adjusted in length to reflect the new weighting values. In addition, the weighting values and slider tools have maintained relative positions vis-à-vis one another. For example, and referring to FIG. 4, the value for Element 3 408 was initially set at 15% and the value for Element 5 409 was set at 30%, or twice the amount of the value for Element 3 408. Referring now to FIG. 5, the value for Element 3 408 has been reduced to 9% and the value for Element 5 409 has been reduced to 18% to account for the increase in Element 2 406, however the relative values have been maintained such that Element 5 409 is still twice the amount of Element 3 408.

Referring now to FIG. 6, Element 2 406 has been further increased to reach the maximum value of 100%. Therefore, the remaining four elements must be decreased down to 0% so the aggregate sum of all weighting values remains at 100%, as shown by the value column 403. Although the remaining four elements all have a 0% weighting value, the relative values of the elements prior to the adjustment has been stored. As a result, if Element 2 406 is moved back down to a value of 58%, as shown in FIG. 5, the four remaining elements would adjust themselves to the relative positions shown in FIG. 5.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 7, an illustrative approach to such a platform will now be provided.

In this illustrative example, the apparatus 700 comprises, in general, a processor 701 that operably couples to a display 200 and a user input interface 702 of choice. This processor 701 can comprise a fixed-purpose platform if desired, but more typically may comprise a partially or wholly programmable platform. So configured, this processor 701 can be configured and arranged (for example, by appropriate programming as will be well understood by those skilled in the art) to carry out one or more of the steps and activities described herein. This can comprise, for example, causing the display 200 to present a plurality of search results as correspond to a general search that has been conducted using a plurality of search criteria. This can also comprise causing the display 200 to present the aforementioned user-alterable graphic user interface elements that serve to illustrate current weighting values as correspond to the search criteria and as are applied when determining a presentation order for those search results.

Those skilled in the art will recognize and understand that such an apparatus 700 may be comprised of a plurality of physically distinct elements as is suggested by the illustration shown in FIG. 7. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, these teachings provide a powerful yet simple and highly intuitive mechanism to permit a user to alter in a desired way the presentation order of a plurality of general search results. Those skilled in the art will recognize and appreciate that these teachings effectively leverage existing practices while also comprising a highly scalable approach that can readily be applied with essentially any number of search criteria. It will also be understood that these teachings can be applied with search criteria that are otherwise unrelated to one another or with search criteria that have a predetermined relationship with one another (as specified, for example, by Boolean algebraic expressions or the like).

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

Once such modification may include, for example, the ability to lock at least one of the plurality of user-alterable graphic user interface elements at a given weighting value to provide at least one locked user-alterable graphic user interface element. As a result, the weighting value of the at least one locked user-alterable graphic user interface element remains unchanged upon the automatic adjustment of the current weighting values as correspond to the non-locked, non-directly-adjusted user-alterable graphic user interface elements. In addition, the at least one locked user-alterable graphic user interface element will not maintain a relative value vis-à-vis the weighting values of each of the non-locked, non-directly adjusted user-alterable graphic user interface elements. However, the non-locked, non-directly adjusted user-alterable graphic user interface elements will continue to maintain their relative values vis-à-vis one another. In addition, the aggregate sum of the current weighting values as correspond to all of the plurality of user-alterable graphic user interface elements (both locked and non-locked) will continue to comprise the particular value.

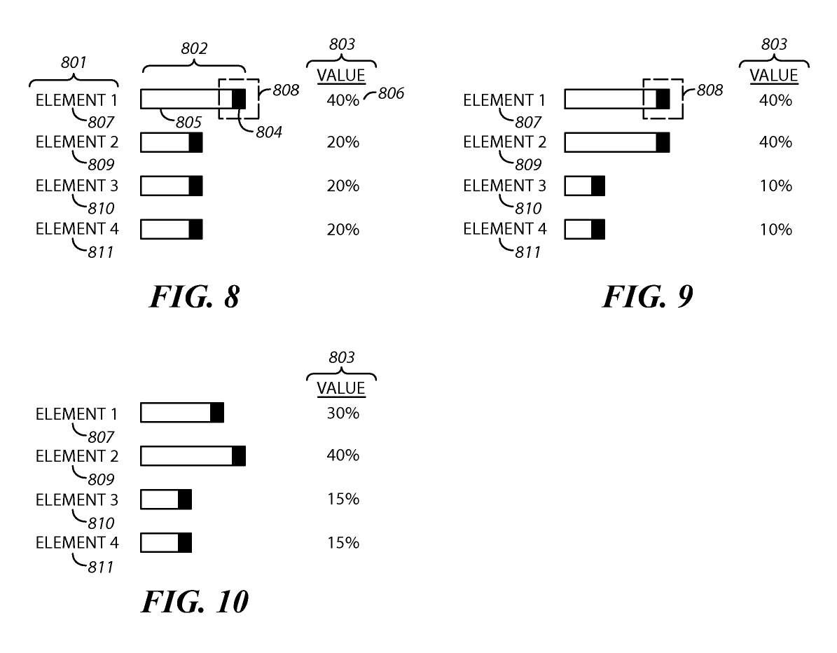

To illustrate, and referring now to FIG. 8, a schematic example of a plurality of user-alterable graphic user interface elements are shown. In this example, a column 801 of four user-alterable graphic user interface elements is provided, with each element relating to a corresponding search criterion. The elements are each graphically depicted by slider tools 802, with each slider tool having an associated weighting value as displayed in the value column 803. Again, the slider tool for each element may be adjusted by selecting the end portion of the tool 804 (using any known computer input device) and sliding the end portion 804 to the right or the left, thereby increasing or decreasing the length portion 805 and the corresponding weighting value 806. It should be noted that in this illustrative example, the aggregate sum of the weighting value totals 100%.

The user may decide that the weighting value of Element 1 807 should remain at 40%, but that the remaining elements need further adjustment. Therefore, the user may “lock” the position 808 of Element 1 807 at 40% such that the position of Element 1 807 will not change even when the remaining elements are adjusted. The user may lock an element in any of a variety of ways, such as, for example, by selecting a “lock” button or function next to Element 1 or by clicking on the weighting value next to Element 1.

Once Element 1 807 has been locked at 40%, the user may then continue to adjust the remaining unlocked elements. The adjustment of the remaining elements will follow the teachings as described above, in which the relative positions of the remaining elements will be stored and adjusted such that the relative positions of the remaining elements are maintained. In this illustration, the user increases Element 2 809 to 40%. As shown in FIG. 9, while Element 1 8107 is locked at 40%, Element 3 810 and Element 4 811 will decrease to 10% to maintain the aggregate sum of 100%. These adjusted positions are shown in FIG. 9, along with the corresponding column of adjusted weighting values 803. It should be noted that the relative positions for Element 3 810 and Element 4 811 have been maintained in the adjustment of Element 2 809. However, the initial relative position of Element 1 807 as to Elements 3 810 and 4 811 shown in FIG. 8 (that is, a value of 40% that is twice that of the 20% value for Elements 3 810 and 4 811) is not maintained. Rather, by locking Element 1 807 the relative position is lost.

By comparison, if Element 1 807 had not been locked, then the relative position of Element 1 807 vis-à-vis the other elements would have been maintained. If the elements were initially set as shown in FIG. 8 and then the user again adjusted Element 2 809 to 40% , but without first locking Element 1 807, then Elements 1, 3, and 4 would adjust relative to one another. This result is shown in FIG. 10 with the resulting values displayed in the value column 803. Element 2 809 has been adjusted up to 40%, so Elements 1, 3 and 4 have been decreased so that the aggregate sum remains at 100%. In the initial settings of FIG. 8, Element 1 (40%) had twice the value of Elements 3 (20%) and 4 (20%). Referring again to FIG. 10, Element 1 (30%) still maintains a relative value of twice the value of Elements 3 (15%) and 4 (15%).

We claim:

1. A method comprising:
providing simultaneously and via a display:
a plurality of search results as correspond to a general search conducted using a plurality of search criteria;
a plurality of user-alterable graphic user interface elements, wherein each of the plurality of user-alterable graphic user interface elements corresponds to at least one of the plurality of search criteria, such that the plurality of user-alterable graphic user interface elements serve to illustrate current weighting values as correspond to the search criteria as are applied when determining a presentation order for the search results;
detecting direct user alteration of a given one of the user-alterable graphic user interface elements, which alteration causes a change in the weighting value that corresponds to the given one of the user-alterable graphic user interface elements;
automatically altering the presentation order for the search results as a function of detecting the direct user alteration of the given one of the plurality of user-alterable graphic user interface elements.

2. The method of claim 1 wherein the plurality of search criteria comprise words.

3. The method of claim 2 wherein the words comprise words that are entered by a user who seeks to conduct the general search.

4. The method of claim 1 wherein at least one of the plurality of user-alterable graphic user interface elements comprises a graphic depiction of at least one of:
a slider tool;
a rotating knob;
a push, hold, and drag button;
a touch screen element;
a select, drag, and drop value.

5. The method of claim 1 further comprising:
providing, via the display, the current weighting values as correspond to at least some of the user-alterable graphic user interface elements.

6. The method of claim 1 wherein detecting direct user alteration of a given one of the user-alterable graphic user interface elements, which alteration causes a change in the weighting value that corresponds to the given one of the user-alterable graphic user interface elements, further comprises automatically altering other of the weighting values as correspond to other of the user-alterable graphic user interface values as a function of the change to the weighting value that corresponds to the given one of the user-alterable graphic user interface element.

7. The method of claim 6 wherein automatically altering other of the weighting values as correspond to other of the user-alterable graphic user interface values as a function of the change to the weighting value that corresponds to the given one of the user-alterable graphic user interface element further comprises automatically altering other of the weighting values as correspond to other of the user-alterable graphic user interface values as a function of the change to the weighting value that corresponds to the given one of the user-alterable graphic user interface element to ensure that an aggregate sum of the current weighting values as correspond to all of the user-alterable graphic user interface elements continues to comprise a particular value.

8. The method of claim 7 wherein automatically altering other of the weighting values as correspond to other of the user-alterable graphic user interface values as a function of the change to the weighting value that corresponds to the given one of the user-alterable graphic user interface element to ensure that an aggregate sum of the current weighting values as correspond to all of the user-alterable graphic user interface elements continues to comprise a particular value further comprises automatically altering other of the weighting values as correspond to other of the user-alterable graphic user interface values as a function of the change to the weighting value that corresponds to the given one of the user-alterable graphic user interface element to ensure that an aggregate sum of the current weighting values as correspond to all of the user-alterable graphic user interface elements continues to comprise a particular value while further ensuring, to an extent reasonably possible, that the current weighting values for each non-user-adjusted user-alterable graphic user interface elements continue to maintain their relative values vis-à-vis one another.

9. The method of claim 8 further comprising:
storing relative value information regarding present relative weighting values of non-user-adjusted user-alterable graphic user interface elements to provide stored relative value information, such that the method will remember and attempt to persist relative differences between automatically adjusted current weight values for non-user-adjusted user-alterable graphic user interface elements notwithstanding previous automatic adjustment of current weighting values to a point of equality.

10. The method of claim 1 wherein providing simultaneously and via a display a plurality of search results as correspond to a general search conducted using a plurality of search criteria further comprises providing a display of a plurality of search results as correspond to a general search conducted using the plurality of search criteria with a plurality of independent general search engines.

11. The method of claim 10 wherein providing simultaneously and via a display a plurality of user-alterable graphic user interface elements further comprises providing a display of a second plurality of user-alterable graphic user interface elements wherein each of the second plurality of user-alterable graphic user interface elements corresponds to a given one of the independent general search engines, such that the plurality of user-alterable graphic user interface elements serve to illustrate current weighting values as correspond to the independent general search engines as are applied when determining a presentation order for the search results.

12. An apparatus comprising:
a display;
a user input interface;
a processor operably coupled to the display and the user input interface and being configured and arranged to:
provide simultaneously and via the display:
a plurality of search results as correspond to a general search conducted using a plurality of search criteria;
a plurality of user-alterable graphic user interface elements, wherein each of the plurality of user-alterable graphic user interface elements corresponds to at least one of the plurality of search criteria, such that the plurality of user-alterable graphic user interface elements serve to illustrate current weighting values as correspond to the search criteria as are applied when determining a presentation order for the search results;
detect direct user alteration via the user input interface of a given one of the user-alterable graphic user interface elements, which alteration causes a change in the weighting value that corresponds to the given one of the user-alterable graphic user interface elements;
automatically alter the presentation order for the search results as a function of detecting the direct user alteration of the given one of the plurality of user-alterable graphic user interface elements.

13. The apparatus of claim 12 wherein the plurality of search criteria comprise words.

14. The apparatus of claim 13 wherein the words comprise words that are entered by a user who seeks to conduct the general search.

15. The apparatus of claim 12 wherein at least one of the plurality of user-alterable graphic user interface elements comprises a graphic depiction of at least one of:
a slider tool;
a rotating knob;
a push, hold, and drag button;
a touch screen element;
a select, drag, and drop value.

16. The apparatus of claim 12 wherein the processor is further configured and arranged to:
provide, via the display, the current weighting values as correspond to at least some of the user-alterable graphic user interface elements.

17. The apparatus of claim 12 wherein the processor is further configured and arranged to detect direct user alteration of a given one of the user-alterable graphic user interface elements, which alteration causes a change in the weighting value that corresponds to the given one of the user-alterable graphic user interface elements, by automatically altering other of the weighting values as correspond to other of the user-alterable graphic user interface values as a function of the change to the weighting value that corresponds to the given one of the user-alterable graphic user interface element.

18. The apparatus of claim 17 wherein the processor is further configured and arranged to automatically alter other of the weighting values as correspond to other of the user-alterable graphic user interface values as a function of the change to the weighting value that corresponds to the given one of the user-alterable graphic user interface element by automatically altering other of the weighting values as correspond to other of the user-alterable graphic user interface values as a function of the change to the weighting value that corresponds to the given one of the user-alterable graphic user interface element to ensure that an aggregate sum of the current weighting values as correspond to all of the user-alterable graphic user interface elements continues to comprise a particular value.

19. The apparatus of claim 18 wherein the processor is further configured and arranged to automatically alter other of the weighting values as correspond to other of the user-alterable graphic user interface values as a function of the change to the weighting value that corresponds to the given one of the user-alterable graphic user interface element to ensure that an aggregate sum of the current weighting values as correspond to all of the user-alterable graphic user interface elements continues to comprise a particular value by automatically altering other of the weighting values as correspond to other of the user-alterable graphic user interface values as a function of the change to the weighting value that corresponds to the given one of the user-alterable graphic user interface element to ensure that an aggregate sum of the current weighting values as correspond to all of the user-alterable graphic user interface elements continues to comprise a particular value while further ensuring, to an extent reasonably possible, that the current weighting values for each non-user-adjusted user-alterable graphic user interface elements continue to maintain their relative values vis-à-vis one another.

20. The apparatus of claim 19 wherein the processor is further configured and arranged to:
store relative value information regarding present relative weighting values of non-user-adjusted user-alterable graphic user interface elements to provide stored relative value information, such that the apparatus will remember and attempt to persist relative differences between automatically adjusted current weight values for non-user-adjusted user-alterable graphic user interface elements notwithstanding previous automatic adjustment of current weighting values to a point of equality.

21. The apparatus of claim 12 wherein the processor is further configured and arranged to provide simultaneously and via the display a plurality of search results as correspond to a general search conducted using a plurality of search criteria by providing a display of a plurality of search results as correspond to a general search conducted using the plurality of search criteria with a plurality of independent general search engines.

22. The apparatus of claim 21 wherein the processor is further configured and arranged to provide simultaneously and via the display a plurality of user-alterable graphic user interface elements by providing a display of a second plurality of user-alterable graphic user interface elements wherein each of the second plurality of user-alterable graphic user interface elements corresponds to a given one of the independent general search engines, such that the plurality of user-alterable graphic user interface elements serve to illustrate current weighting values as correspond to the independent general search engines as are applied when determining a presentation order for the search results.
